(19) United States
(12) Patent Application Publication
(10) Pub. No.: US 2011/0306229 A1
(43) Pub. Date: Dec. 15, 2011

(54) CONNECTOR ASSEMBLY

(75) Inventors: Masayoshi KATSUI, Kawasaki (JP); Kazuaki TAKAO, Kawasaki (JP)

(73) Assignee: FUJITSU LIMITED, Kawasaki-shi (JP)

(21) Appl. No.: 13/158,831

(22) Filed: Jun. 13, 2011

(30) Foreign Application Priority Data
Jun. 15, 2010 (JP) 2010-135671

(51) Int. Cl. H01R 13/62

(52) U.S. Cl. 439/345

(57) ABSTRACT

A connector assembly includes a plug connector including a plug housing and an engaging portion that outwardly protrudes from each of side-surfaces of the plug housing, and a receptacle connector including a receptacle housing and a metal fitting that is formed at each of side walls of the receptacle housing, the metal fitting including a retaining portion that is formed at a lower part of the metal fitting and is exposed at a lower part of each of the side walls, and a beam portion that is formed at an upper part of the metal fitting and inwardly projects from each of the side walls of the receptacle housing at a height above a bottom surface of the receptacle housing, the beam portion forming a space with the bottom surface of the receptacle housing to receive the engaging portion of the plug connector.

### CROSS-REFERENCE TO RELATED APPLICATIONS

This application is based upon and claims the benefit of priority of the prior Japanese Patent Application No. 2010-135671, filed on Jun. 15, 2010, the entire contents of which are incorporated herein by reference.

### FIELD

The embodiments discussed herein are related to a connector assembly.

### BACKGROUND

Right angle connector assemblies are widely used as components satisfying demands for reduction in thickness (profile) of mobile devices and the like. A typical connector assembly includes a receptacle connector fixed to a printed circuit board and a plug connector received in the receptacle connector. The right angle connector assemblies are broadly divided into two types depending on the direction of insertion or removal of the plug connector to or from the receptacle connector. One of the two types is a horizontal insertion/removal type in which the plug connector is horizontally inserted into or removed from the receptacle connector. The other type is a vertical insertion/removal type (including insertion/removal in the direction which is not strictly vertical but from above or upward) in which the plug connector is vertically inserted into or removed from the receptacle connector. In terms of the workability during insertion or removal of the plug connector to or from the receptacle connector fixed to the printed circuit board, the vertical insertion/removal type may be more advantageous than the other one. The reason is as follows. Assembly is performed while the plug connector is generally connected to a cable. In the horizontal insertion/removal type, the cable connected to the plug connector horizontally extends therefrom. Accordingly, the plug connector has to be carefully inserted into or removed from the receptacle connector so that the cable does not contact other components on the printed circuit board. The vertical insertion/removal type is free from such care.

An exemplary structure of a connector assembly of the vertical insertion/removal type is described with reference to FIGS. 7A to 7C. FIG. 7A is a perspective view of a receptacle connector 10 and a plug connector 20. The receptacle connector 10 includes a receptacle housing 11, receptacle contacts 13 arranged at the back (relative to the left side of the figure indicating “front”) of the receptacle housing 11, and metal fittings 14 arranged in front ends of both side walls of the receptacle housing 11, the metal fittings being secured to the printed circuit board. The receptacle connector 10 further includes projections 12, arranged in upper parts of both the side walls, for preventing removal of the plug connector 20.

The plug connector 20 includes a plug housing 21 and plug contacts (not illustrated) arranged in the plug housing 21, the plug contacts being connected to cables 23. The plug connector 20 has projection receiving portions 22 in upper parts of both side walls of the plug housing 21, the projection receiving portions 22 being engaged with the projections 12 of the receptacle housing 11.

FIG. 7B illustrates the connector assembly after insertion of the plug connector 20 into the receptacle connector 10 from above. In such a state, the plug contacts (not illustrated) mate with the receptacle contacts 13 to achieve electrical connection. The projections 12 of the receptacle housing 11 engage the projection receiving portions 22 of the plug connector 20, thus preventing upward removal of the plug connector 20.

FIG. 7C is a side view of the connector assembly of FIG. 7B. The metal fitting 14 projecting from the receptacle housing 11 is secured to a printed circuit board 30 by soldering. The receptacle contact 13 projecting from the rear wall of the receptacle housing 11 is connected to a circuit pattern of the printed circuit board 30 by soldering.

As a structure for preventing removal of a plug connector from a receptacle connector, there has known a structure in which fastening flanges horizontally arranged on the outer surfaces of both side walls of a plug housing are fitted onto the lower surfaces of fastening hooks horizontally arranged on the inner surfaces of side walls of a receptacle housing to fasten the plug connector to the receptacle connector so that upward removal is prevented. Japanese Laid-open Patent Publication No. 9-259992 is an example of related art.

As described above, the right angle connector assemblies of the vertical insertion/removal type for mounting on a printed circuit board are widely used because such a connector assembly allows the profile of a device including the connector assembly to be reduced and the workability is excellent. The connector assemblies have a lock mechanism in which projections are arranged on outer walls of a plug housing, receiving portions are arranged on inner walls of a receptacle housing, and the projections engage the receiving portions to prevent removal of the plug connector even when an upward force acts on the connector assembly.

Generally, it is rare that connectors constituting a connector assembly mounted on a printed circuit board are unmated from each other after the completion of assembly of a product including the connector assembly. In some cases, however, one connector is inserted into or removed from the other connector in order to undergo various tests before the assembly of the product. In such a case, if the above-described lock mechanism includes molded components of the housings of the connectors, a lock projection or receiving portion is worn away owing to the insertion and removal. Disadvantageously, the lock loosens and the connector may be easily removed from the other one.

When the outer dimensions of a connector are small (for example, 4.5×4.5×1.5 mm), it is difficult to unmate a plug connector from a receptacle connector while holding the housing of the plug connector. Therefore, the plug connector is unmated from the receptacle connector while a cable is raised. In this case, the projection or receiving portion is significantly damaged (worn away). The reliability of connection of the damaged connector assembly is degraded. After shipment of a product including the damaged connector assembly, a trouble may be caused because the product has a loose contact.

### SUMMARY

According to an aspect of the invention, a connector assembly includes a plug connector including a plug housing and an engaging portion that outwardly protrudes from each of opposite first and second side-surfaces of the plug housing, and a receptacle connector that is mated with the plug connector, the receptacle connector including a receptacle housing that accommodates the plug connector, and a metal fitting that is formed at each of opposite first and second side walls of the receptacle housing, the metal fitting including a retaining portion that is formed at a lower part of the metal fitting and is exposed at a lower part of each of the first and second side walls of the receptacle housing, and a beam portion that is formed at an upper part of the metal fitting and inwardly projects from each of the first and second side walls of the receptacle housing at a height above a bottom surface of the receptacle housing, the beam portion forming a space with the bottom surface of the receptacle housing to receive the engaging portion of the plug connector.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A to 1C illustrate a connector assembly according to a first embodiment.

FIG. 2 is a perspective view of the connector assembly according to the first embodiment when viewed from the rear.

FIGS. 3A to 3D illustrate a method of inserting a plug connector into a receptacle connector according to the first embodiment.

FIGS. 4A to 4D illustrate a method of withdrawing the plug connector into a receptacle connector according to the first embodiment.

FIGS. 5A to 5C illustrate a connector assembly according to a second embodiment.

FIGS. 6A to 6C illustrate a method of inserting a plug connector into a receptacle connector according to the second embodiment.

FIGS. 7A to 7C illustrate an exemplary structure of a connector assembly of the vertical insertion/removal type according to a related art.

### DESCRIPTION OF EMBODIMENTS

### First Embodiment

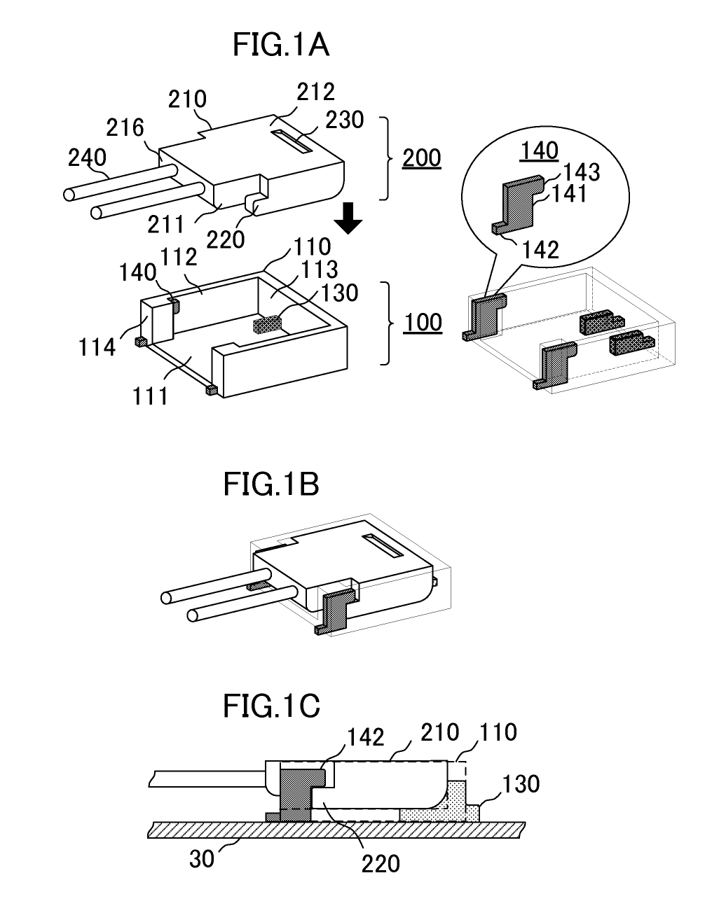

A connector assembly according to a first embodiment is described with reference to FIGS. 1A to 4D. The connector assembly according to the first embodiment includes receptacle contacts of the right angle type and a plug connector of a vertical insertion/removal type. The plug connector is inserted from above into a receptacle connector and is mated thereto. As for mounting onto a printed circuit board, surface mounting is performed.

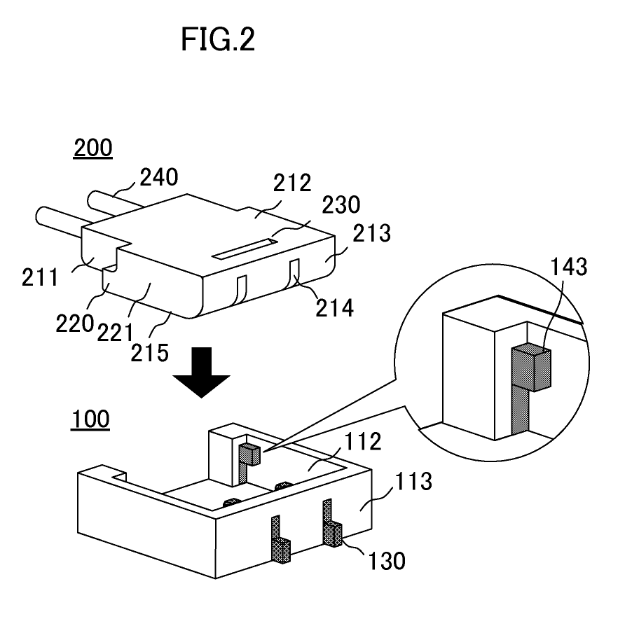

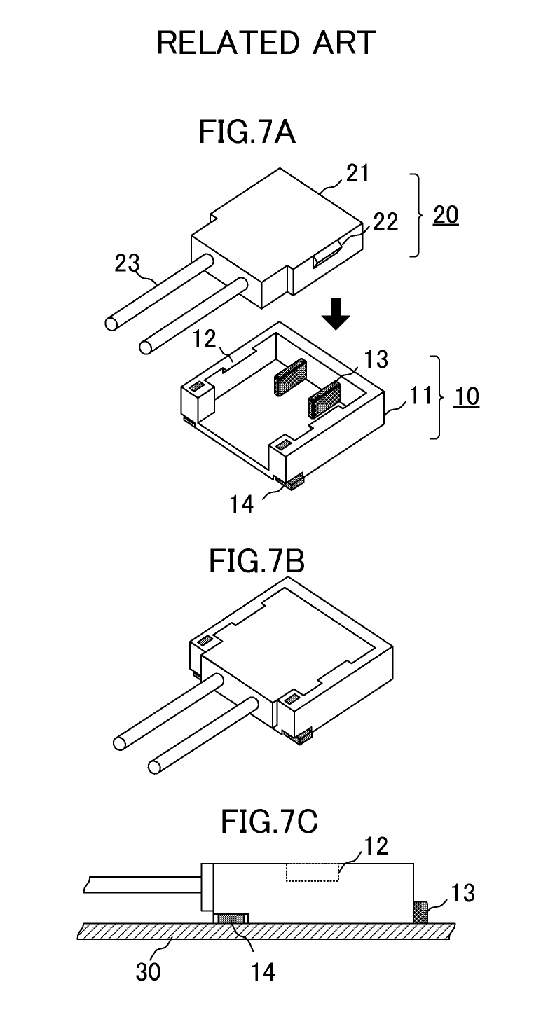

FIGS. 1A to 1C illustrate an exemplary structure of the connector assembly according to this embodiment in a manner similar to FIGS. 7A to 7C described above. The structure of the connector assembly is described mainly using FIGS. 1A to 1C. The structure is described with reference to FIG. 2. FIG. 2 is a perspective view of the connector assembly of FIG. 1 when viewed from the rear.

FIG. 1A is a perspective view of a receptacle connector 100 and a plug connector 200. Right part of FIG. 1A illustrates the receptacle connector 100 including a receptacle housing 110 that is illustrated as being transparent.

Referring to FIG. 1A, the receptacle connector 100 includes the receptacle housing 110, the receptacle contacts, indicated at 130, and metal fittings 140. The receptacle housing 110 has a shape like a box with an open top and an open front. The receptacle housing 110 includes a bottom surface 111 and walls extending upward from three sides of the bottom surface 111. A top opening of the receptacle housing 110 is for insertion and removal of the plug connector 200. A front opening thereof is for extension of cables 240 connected to the plug connector 200 upon insertion of the plug connector 200.

The receptacle contacts 130 are arranged at the back of the receptacle housing 110 such that the receptacle contacts 130 rise upward and are electrically connected to plug contacts (not illustrated) in the plug connector 200 inserted from above. Lower part of each receptacle contact 130 projects from the outer surface of the rear wall, indicated at 113, of the receptacle housing 110 and is joined to a circuit pattern of a printed circuit board 30 by soldering. FIG. 2 illustrates the receptacle contacts 130 projecting from the outer surface of the rear wall 113 of the receptacle housing 110. FIG. 1A illustrates the two receptacle contacts 130. The number of receptacle contacts is not limited to two. More receptacle contacts 130 may be arranged.

A metal fitting 140 is inverted Z-shaped as illustrated in an enlarged view in right part of FIG. 1A. The metal fitting 140 is insert-molded in front parts each of both side walls, indicated at 112, of the receptacle housing 110. The metal fitting 140 includes a body portion 141, a retaining portion 142, and a beam portion 143. The body portion 141 projects inwardly from the side wall 112 of the receptacle housing 110 and extends upwardly from a lower part of each of the side walls 112 of the receptacle housing 110 to an upper part of each of the side walls 112 of the receptacle housing 110. The retaining portion 142 is formed at a lower part of the body portion 141 and extends horizontally from the body portion 141 to be exposed on the outside of the receptacle housing 110. The retaining portion 142 forwardly projects from the receptacle housing 110. The retaining portion 142 is secured to a printed circuit board 30 by soldering. The metal fitting 140 includes a beam portion 143, serving as upper part of the body portion 141 thereof, projecting inwardly from the side wall 112 of the receptacle housing 110 and extending horizontally from the body portion 141 in a direction of a rear wall 113 of the receptacle housing 110 by a predetermined distance along each of the side walls 112 of the receptacle housing 110 at a predetermined height above a bottom surface 111 of the receptacle housing 110. The beam portion 143 functions as a lock against upward movement of the plug connector 200. The beam portion 143 is described in detail later. FIG. 2 illustrates the beam portion 143 which projects inwardly from the receptacle housing 110 and horizontally extends along the side wall 112.

In this embodiment, the metal fittings 140 are insert-molded in the receptacle housing 110. A slit may be vertically formed in each side wall 112 and the metal fitting 140 may be pressed into the slit. The retaining portions 142 project from the front surface 114 of the receptacle housing 110. The retaining portions 142 may be exposed at the front surface 114 or bottom surface 111 without projecting therefrom and the exposed surfaces of the retaining portions 142 may be joined to the printed circuit board 30 by soldering.

The plug connector 200 includes a plug housing 210, the cables 240, and the plug contacts (not illustrated). The plug housing 210 has a front surface 216, left and right side-surfaces 211, a rear surface 213, a top surface 212 and a bottom surface 215. One end of each cable 240 is connected to the plug contact and the other end thereof extends from the front surface 216 of the plug housing 210 and is connected to, for example, a circuit module.

The plug housing 210 includes raised portions 221 protruding from the respective side-surfaces 211 thereof. The top surface of each of the raised portions 221 is included in the top surface 212 of the plug housing 210. The raised portions 221 are formed the side-surfaces 211 adjacent to the rear surface 213 of the plug housing 210. A lower part of each of the raised portions 221 extends in the direction of the front surface 216 of the plug housing 210 to provide an engaging portion 220. The engaging portion 220 has a predetermined height from the bottom surface 215 of the plug housing 210. The engaging portion 220 is inserted into a space formed between the metal fitting 140 and the bottom surface 111 of the receptacle housing 110. Namely the beam portion 143 forms a recess with the body portion 141 and the bottom surface 111 of the receptacle housing 110. The engaging portion 220 is described in detail later.

The plug housing 210 includes the top surface 212 having a catch 230 for withdrawing the plug connector 200 from the receptacle connector 100. The plug housing 210 further includes a rear surface 213 that is formed in a curved surface (refer to FIG. 2). The plug housing 210 has two slits 214 extending from the rear surface 213 thereof to the bottom surface 215 thereof. The placement of the curved surface prevents the lower part of the rear surface 213 of the plug connector 200 from hitting the rear wall 113 of the receptacle housing 110 and being caught by the rear wall 113 upon insertion of the plug connector 200 into the receptacle connector 100 and upon removal of the plug connector 200 from the receptacle connector 100. The slits 214 are configured to guide the receptacle contacts 130 into the plug housing 210 and mate the plug contacts (not illustrated) to the receptacle contacts 130 when the plug connector 200 is inserted into the receptacle connector 100.

FIGS. 1B and 1C depict a mated condition of the plug connector 200 and the receptacle connector 100. In the figures, the receptacle housing 110 is illustrated as being transparent. As illustrated in FIGS. 1B and 1C, each engaging portion 220 of the plug connector 200 is received between the lower surface of the beam portion 143 of the corresponding metal fitting 140 and the bottom surface 111 of the receptacle housing 110. Accordingly, even if an upward force acts on the plug connector 200 in the mated condition, the plug connector 200 is locked by the beam portion 143.

In the mated condition of the plug connector 200 and the receptacle connector 100, there is no gap between the rear surface 213 of the plug connector 200 and the rear wall 113 of the receptacle housing 110 and the front surface of each engaging portion 220 abuts against the rear surface of the body portion 141 of the corresponding metal fitting 140. Consequently, the horizontal movement of the plug connector 200 is also restricted.

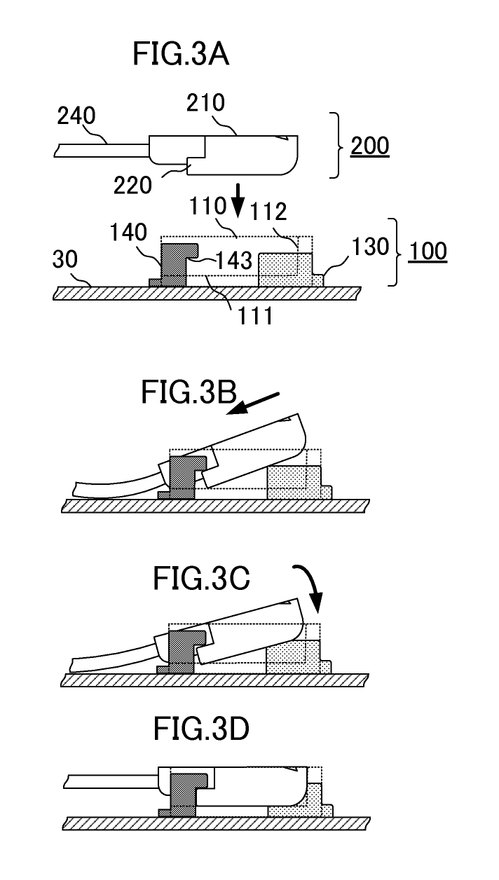

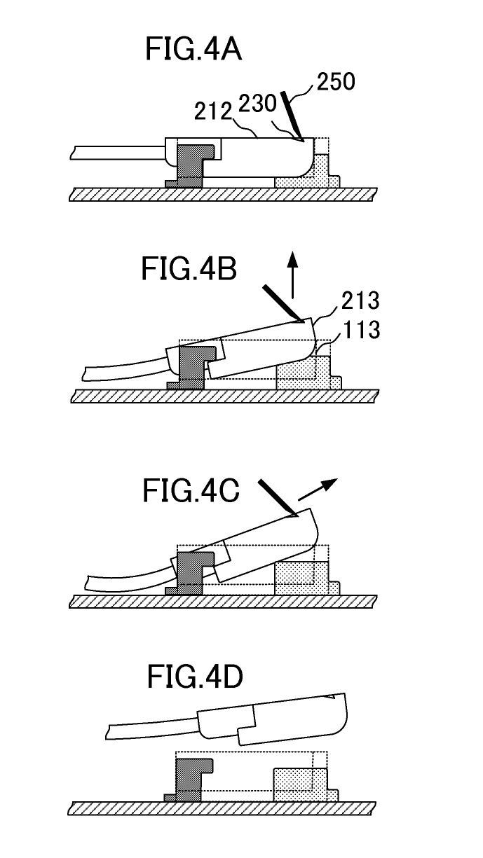

A method of mating the plug connector 200 to the receptacle connector 100 in this embodiment is described with reference to FIGS. 3A to 3D and a method of withdrawing the plug connector 200 from the receptacle connector 100 is described with reference to FIGS. 4A to 4D. In FIGS. 3A to 4D, the receptacle housing 110 is illustrated as being transparent so that mating the plug connector 200 to the receptacle connector 100 and unmating the plug connector 200 from the receptacle connector 100 can be seen.

The method of mating the plug connector 200 to the receptacle connector 100 is first described. Referring to FIG. 3A, the plug connector 200 is positioned above the receptacle connector 100 mounted on the printed circuit board 30. At this time, the direction in which the cables 240 connected to the plug connector 200 extend therefrom is aligned with the forward direction of the receptacle connector 100 (i.e., the left in FIG. 3A).

Above the receptacle connector 100, the front part, from which the cables 240 extend, of the plug connector 200 is tilted downward and each engaging portion 220 of the plug connector 200 is diagonally inserted in an inclined state between the lower surface of the beam portion 143 of the metal fitting 140 and the bottom surface 111 of the receptacle housing 110 (see FIG. 3B).

Subsequently, the rear part of the top surface 212 of the plug connector 200 is downwardly pressed such that the plug connector 200 is pressed into the receptacle housing 110 along the rear wall 113. Pressing the plug connector 200 allows the receptacle contacts 130 in the receptacle housing 110 to enter the plug housing 210 through the slits 214 of the plug housing 210, so that the receptacle contacts 130 mate with the plug contacts (not illustrated). When the plug connector 200 is pressed into the receptacle housing 110 until the plug connector 200 is horizontally received therein, the mating of the connectors (i.e., the plug connector 200 and the receptacle connector 100) is completed.

The method of withdrawing the plug connector 200 from the receptacle connector 100 is described. FIG. 4A illustrates a state in which while the plug connector 200 is mated with the receptacle connector 100, one end of a puller 250 is placed in the catch 230 on the top surface 212 of the plug connector 200. The puller 250 is a plate-shaped tool having a tapered end and a width to fit within a recess, serving as the catch 230.

In the state of FIG. 4A, the puller 250 is raised while being caught by the catch 230. Consequently, the rear surface 213 of the plug housing 210 is pulled upward along the rear wall 113 of the receptacle housing 110 (see FIG. 4B)

When the rear surface 213 of the plug housing 210 is pulled up to a predetermined level from the receptacle housing 110 (for example, a level of approximately two thirds of the height of the plug housing 210), the puller 250 is pressed upward to the right, so that each engaging portion 220 is disengaged from the metal fitting 140 (see FIG. 4C).

After confirmation of the disengagement of the engaging portion 220 from the metal fitting 140, the plug housing 210 is lifted, so that the withdrawing is completed (see FIG. 4D).

In the first embodiment, the receptacle housing 110 and the plug housing 210 are of, for example, liquid crystal polymer (LCP) and the metal fittings 140 are of, for example, stainless used steel (SUS) or copper alloy. The outer dimensions of the receptacle connector 100 are 4.5 mm (width)×4.5 mm (depth)×1.5 mm (height).

### Second Embodiment

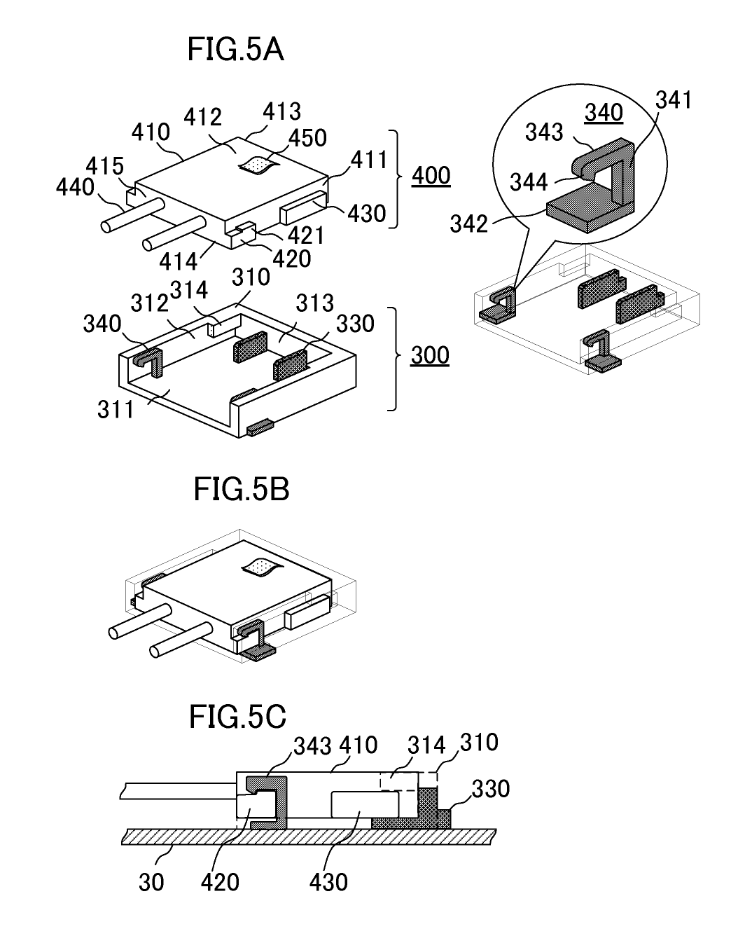

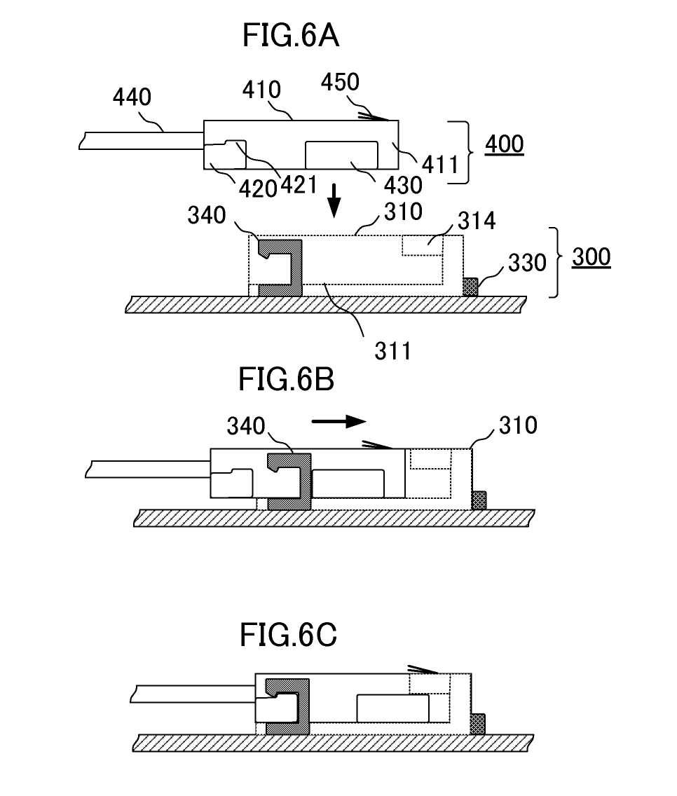

In the above-described first embodiment, the engaging portion 220 is disposed on each of the side surfaces 211 of the plug housing 210 and the engaging portion 220 is inserted between the metal fitting 140 and the bottom surface 111 of the receptacle housing 110. According to a second embodiment, two engaging portions (i.e., a first engaging portion and a second engaging portion) are arranged on each side wall of the plug housing 210 and horizontally extend along the side walls. The first engaging portion is inserted between a metal fitting and the bottom surface of the receptacle housing and the second engaging portion is inserted between a receiving portion of the receptacle housing and the bottom surface of the receptacle housing. The second embodiment is described with reference to FIGS. 5A to 6C.

FIGS. 5A to 5C illustrate an exemplary structure of a connector assembly according to the second embodiment. FIG. 5A is a perspective view of a receptacle connector 300 and a plug connector 400. Right part of FIG. 5A depicts the receptacle connector 300 including a receptacle housing 310 that is illustrated as being transparent.

The receptacle connector 300 includes the receptacle housing 310, receptacle contacts 330, and metal fittings 340. The receptacle housing 310 has a shape like a box with an open top and an open front in a manner similar to the first embodiment. The receptacle housing 310 includes a bottom surface 311 and walls extending upward from three sides of the bottom surface 311. The receptacle housing 310 further includes receiving portions 314 arranged on the side walls 312 at the back of the receptacle housing 310 such that each receiving portion 314 inwardly projects from the side wall 312 and horizontally extends along each of the side walls 312 at a predetermined height above the bottom surface 311. The metal fitting 340 and the receiving portion 314 have a space therebetween in a horizontal direction along the side wall 312 of the receptacle housing 310 to receive a second engaging portion 430 described later.

The receptacle contacts 330 are arranged at the back of the receptacle housing 310 such that the receptacle contacts 330 rise upwardly from the bottom surface 311 of the receptacle housing 310. Lower part of each receptacle contact 330 projects from the outer surface of the rear wall, indicated at 313, of the receptacle housing 310 and is joined to a circuit pattern of a printed circuit board 30 by soldering in a manner similar to the first embodiment.

The metal fitting 340 looks like a U-shape turned sideways when viewed from the side. The metal fitting 340 is insert-molded within the front part of the side wall 312 and bottom surface 311 of the receptacle housing 310. The metal fitting 340 includes a body portion 341, a retaining portion 342 and a beam portion 343. The body portion 341 projects inwardly from the side wall 312 of the receptacle housing 110 and extends upwardly from a lower part of each of the side walls 312 of the receptacle housing 310 to an upper part of each of the side walls 312 of the receptacle housing 310. The retaining portion 342 is formed at a lower part of the body portion 341 and extends horizontally from the body portion 341 to be exposed on the outside of the receptacle housing 310. The retaining portion 342 projects outward from each of the side walls 312 of the receptacle housing 310. The retaining portion 342 is secured to the printed circuit board 30 by soldering. The metal fitting 340 includes a beam portion 343, serving as upper part of the body portion 341 thereof, projecting inwardly from the side wall 312 of the receptacle housing 310 and extending horizontally from the body portion 341 in a direction of the open front of the receptacle housing by a predetermined distance along each of the side walls 312 of the receptacle housing 310 at a predetermined height above the bottom surface 311 of the receptacle housing 310. The beam portion 343 includes a horizontal lock 344 that projects downwardly from the lower surface of the extending end of the beam portion 343. The metal fitting 340 and the receiving portion 314 have a space therebetween in a horizontal direction.

The plug connector 400 includes a plug housing 410, cables 440, and plug contacts (not illustrated). The plug housing 410 has a front surface 415, left and right side-surfaces 411, a rear surface 413, a top surface 412 and a bottom surface 414. One end of each cable 440 is connected to the corresponding plug contact in the plug housing 410 and the other end thereof extends from the front surface 415 of the plug housing 410 and is connected to, for example, a circuit module (not illustrated) in a manner similar to the first embodiment.

The plug housing 410 further includes a first engaging portion 420 and a second engaging portion 430 arranged on each side surface 411 thereof such that the first and second portions protrude from the side surface 411. The first engaging portion 420 and the second engaging portion 430 are arranged in a horizontal direction along the side-surfaces 411 of the plug housing 410. The first engaging portion 420 and the second engaging portion 430 have a space therebetween in a horizontal direction along the side-wall 411 of the plug housing 410 to receive the metal fitting 340. The first engaging portion 420 and the second engaging portion 430 are arranged at a predetermined level below the top surface of the plug housing 410 such that the bottom surfaces of the first and second portions are included in the bottom surface 414 of the plug housing 410. When the first engaging portion 420 is viewed from the side, a portion, corresponding to the upper side, of the first engaging portion 420 has a protrusion that serves as a horizontal-lock receiving portion 421. The first engaging portion 420 and the second engaging portion 430 are provided on each of the left and right side surfaces 411.

The plug housing 410 includes the top surface 412 which is provided with a tape 450 for withdrawing the plug connector 400 from the receptacle connector 300. The plug connector 400 has slits (not illustrated) arranged on the rear surface 413 and the bottom surface 414 thereof in a manner similar to the first embodiment.

FIGS. 5B and 5C depict a mated condition of the plug connector 400 and the receptacle connector 300. In the figures, the receptacle housing 310 is illustrated as being transparent. As illustrated in FIGS. 5B and 5C, each first engaging portion 420 of the plug connector 400 is received between the lower surface of the beam portion 343 of the corresponding metal fitting 340 and the bottom surface 311 of the receptacle housing 310. Each second engaging portion 430 is inserted into a space formed between the lower surface of the corresponding receiving portion 314 of the receptacle housing 310 and the bottom surface 311 of the receptacle housing 310. Accordingly, even if an upward force acts on the plug connector 400 in the mated condition, the plug connector 400 is locked by the first engaging portions 420 and the second engaging portions 430. The horizontal-lock receiving portion 421 of each first engaging portion 420 is fitted between the horizontal lock 344 and the body portion 341 of the metal fitting 340, thus restricting the horizontal movement of the plug connector 400.

A method of mating the plug connector 400 to the receptacle connector 300 is described with reference to FIGS. 6A to 6C. In FIGS. 6A to 6C, the receptacle housing 310 is illustrated as being transparent so that the mating or unmating of the receptacle connector 300 to or from the plug connector 400 is readily seen.

First, the plug connector 400 is positioned above the receptacle connector 300 such that the surface of the plug connector 400 from which the cables 440 extend faces in the forward direction of the receptacle connector 300 (i.e., the left in FIG. 6A) and each second engaging portion 430 of the plug connector 400 is positioned just above a space between the metal fitting 340 and the receiving portion 314 of the receptacle housing 310. In this state, the plug connector 400 is moved downwardly until the lower surface thereof contacts the bottom surface 311 of the receptacle housing 310 (see FIG. 6A).

Subsequently, the plug connector 400 is slit to the rear wall 313 of the receptacle housing 310 (i.e., the right in FIG. 6B). This sliding of the plug connector 400 allows each first engaging portion 420 to enter between the beam portion 343 of the corresponding metal fitting 340 and the bottom surface 311 of the receptacle housing 310 and allows each second engaging portion 430 to enter between the corresponding receiving portion 314 of the receptacle housing 310 and the bottom surface 311. This sliding is stopped when the first engaging portion 420 abuts against the body portion 341 of the corresponding metal fitting 340. Thus, the insertion of the plug connector 400 into the receptacle connector 300 is completed (see FIG. 6C).

At the completion of the insertion, the horizontal-lock receiving portion 421 of each first engaging portion 420 is fitted between the horizontal lock 344 and the body portion 341 of the corresponding metal fitting 340. In this state, the horizontal movement of the plug connector 400 is restricted. In addition, the upward movement of the plug connector 400 is restricted because each first engaging portion 420 is locked by the beam portion 343 of the corresponding metal fitting 340 and each second engaging portion 430 is locked by the corresponding receiving portion 314 of the receptacle housing 310.

Withdrawing the plug connector 400 from the receptacle connector 300 is the reverse of operation in FIGS. 6A to 6C. In other words, the plug connector 400 is slid to the left and is lifted and is then withdrawn. At this time, the tape 450 for withdrawing is picked up with a tool, such as tweezers, and the plug connector 400 is withdrawn.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A connector assembly comprising:
a plug connector including
a plug housing, and
an engaging portion that outwardly protrudes from each of opposite first and second side-surfaces of the plug housing; and
a receptacle connector that is mated with the plug connector, the receptacle connector including
a receptacle housing that accommodates the plug connector, and
a metal fitting that is formed at each of opposite first and second side walls of the receptacle housing, the metal fitting including
a retaining portion that is formed at a lower part of the metal fitting and is exposed at a lower part of each of the first and second side walls of the receptacle housing, and
a beam portion that is formed at an upper part of the metal fitting and inwardly projects from each of the first and second side walls of the receptacle housing at a height above a bottom surface of the receptacle housing, the beam portion forming a space with the bottom surface of the receptacle housing to receive the engaging portion of the plug connector.

2. The connector assembly according to claim 1, wherein the plug housing of the plug connector includes one of a recess, a protrusion, and a tape member, provided on a top surface of the housing, for withdrawing the plug connector.

3. The connector assembly according to claim 1, wherein the metal fitting is insert-molded or press-fitted in the receptacle housing.

4. The connector assembly according to claim 1, wherein the plug housing has a front surface and a rear surface, and the rear surface of the plug housing is formed in a curved surface, the receptacle housing has an open top, an open front, and a rear wall, the metal fitting is located adjacent to the open front and includes a body portion that upwardly extends from a part of the retaining portion to a part of the beam portion and inwardly projects from each of the first and second side-walls of the receptacle housing, and the beam portion extends from the body portion along each of the first and second side walls of the receptacle housing in a direction of the rear wall of the receptacle housing.

5. The connector assembly according to claim 4, wherein the engaging portion of the plug connector is engaged with metal fitting when the engaging portion is inserted into the space between the beam portion and the bottom surface of the receptacle housing in an inclined state from above and a rear part of the top surface of the plug connector is downwardly pressed such that the plug connector is pressed into the receptacle housing along the rear wall of the receptacle housing.

6. The connector assembly according to claim 1, wherein the engaging portion of the plug connector includes a first engaging portion having a horizontal lock receiving portion that is a protrusion formed in an upper part thereof and a second engaging portion, and the first engaging portion and the second engaging portion are arranged in a horizontal direction along each of the first and second side-surfaces of the plug housing, wherein the receptacle housing further includes a receiving portion that inwardly projects from each of the first and second side walls of the receptacle housing, the metal fitting and the receiving portion are arranged in a horizontal direction along each of the first and second side walls of the receptacle housing, and the receiving portion forms a space with the bottom surface of the receptacle housing to receive the second engaging portion, and the beam portion has a horizontal lock that projects downwardly from a lower surface of an end of the beam portion and is engaged with the horizontal lock receiving portion of the first engaging portion upon insertion of the plug connector into the receptacle connector.

7. The connector assembly according to claim 6, wherein the receptacle housing has an open top and an open front and a rear wall, the metal fitting is located adjacent to the open front and includes a body portion that upwardly extends from a part of the retaining portion to a part of the beam portion and inwardly projects from each of the first and second side-walls of the receptacle housing, the beam portion extends from the body portion along each of the first and second side walls of the receptacle housing in a direction of the open front of the receptacle housing, and the receiving portion is located adjacent to the rear wall.

8. The connector assembly according to claim 7, wherein the first engaging portion of the plug connector is engaged with the metal fitting and the second engaging portion is engaged with the receiving portion when the second engaging portion of the plug connector is inserted into a space between the metal fitting and the receiving portion from above the receptacle connector and is slit to the rear wall of the second housing.
